(19) United States
(12) Patent Application Publication
(10) Pub. No.: US 2015/0000176 A1
(43) Pub. Date: Jan. 1, 2015

(54) Modular Lure

(71) Applicant: Eric D. PETTET, Riverside, CA (US)

(72) Inventor: Eric D. PETTET, Riverside, CA (US)

(21) Appl. No.: 14/311,246

(22) Filed: Jun. 21, 2014

Related U.S. Application Data
(60) Provisional application No. 61/839,857, filed on Jun. 26, 2013.

(51) Int. Cl. A01K 85/18; A01K 85/01

(52) U.S. Cl. CPC A01K 85/18; A01K 85/01
USPC 43/17.6; 43/42.09

(57) ABSTRACT

A modular lure with a light function, whose components can be selected and swapped out to appeal to particular fish, whose shape imparts a rhythmic motion to it upon retrieval, whose tail has a retaining cavity for skirts and tubes, bait, and a light-diffusion attachment, whose one-piece hitch wire provides quick, easy and secure hook attachment, and whose power supply creates an inductive energy field around the lure.

### CROSS-REFERENCE TO RELATED APPLICATIONS

This application claims benefit of priority from Provisional Application No. 61/839,857, filed on Jun. 26, 2013, the disclosure of which is incorporated by reference.

### BACKGROUND OF THE INVENTION

No prior art exists establishing a modular application with fishing lures. Previous art illustrates that non-modular applications utilize static principles inherent to their function, having a limiting nature within their design affecting their performance. As such, they do not offer integration and interchangeability within the limitations they convey. Nor do they offer a variety of features in multiple combinations, common with modularity, therefore not utilizing all the advantages known to attract fish within what is currently known in the art of fishing.

### BRIEF SUMMARY OF THE INVENTION

This lure comprises various interchangeable modules, encompassing attraction methods including a means of self-illumination. A measurable and fish-attracting energy field surrounds the lure, which is a direct benefit derived from electrical current flowing through a tubular conductor when placed into water, permitting effective fishing with the line extended straight down, without needing to impart motion to the lure. In addition, integrating multiple attachments into a modular system of combined components provides a broader spectrum of capabilities. This new and novel design possesses many features that, until now, have not been included in combination with characteristics having the advantage of enhancing an anglers potential to attract both freshwater and saltwater species. In addition, the features extend the angler's fishing time into the night and earlier morning.

Modularity is new and novel when applied to the fishing arts. This lure system allows an angler to specify and change, add to, or modify to their best advantage, any of the modular parts during their fishing experience.

This new concept contains several advantages that are shared across various lure sizes, permitting the angler to optimize the lure for the size and type of fish targeted.

A principal feature is the ability to mix and match modular components of a variety of colors—solid, translucent and/or transparent—which, when combined, further increases the attraction of fish.

### BRIEF DESCRIPTION OF THE DRAWINGS

The following drawings comprise a visual reference of parts and features;

FIG. 1 illustrates the profile for two different lure sizes of the same design, having similar features with similar forms, possessing minor design changes benefiting the lure's function pertaining to its size.

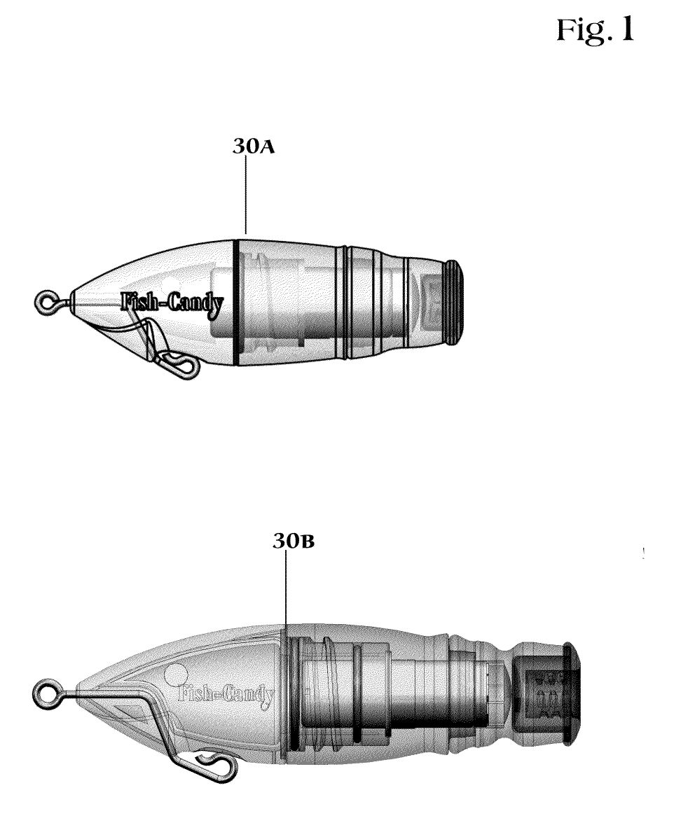

FIG. 2 is an exploded view illustrating features and assembly structure.

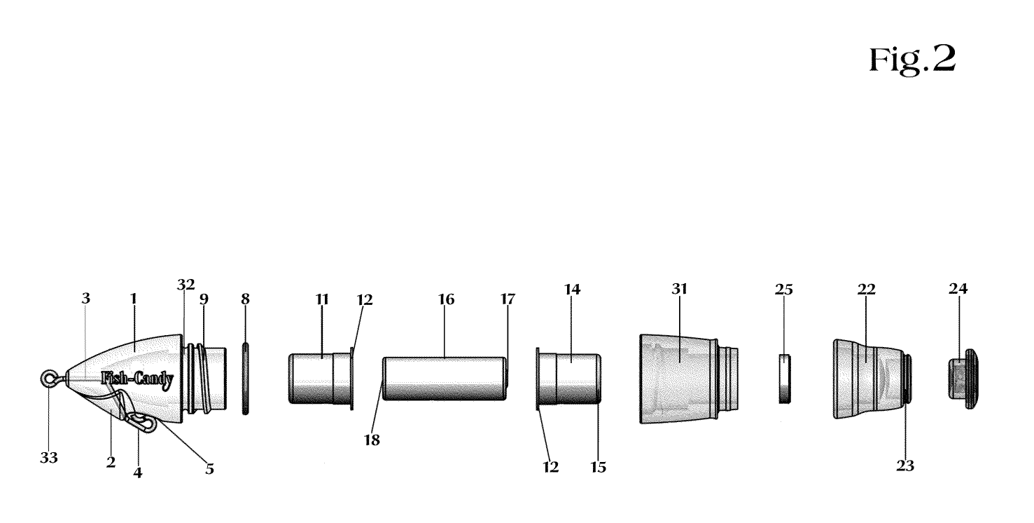

FIG. 3 shows the profile and assembly components and features of the lure's Head.

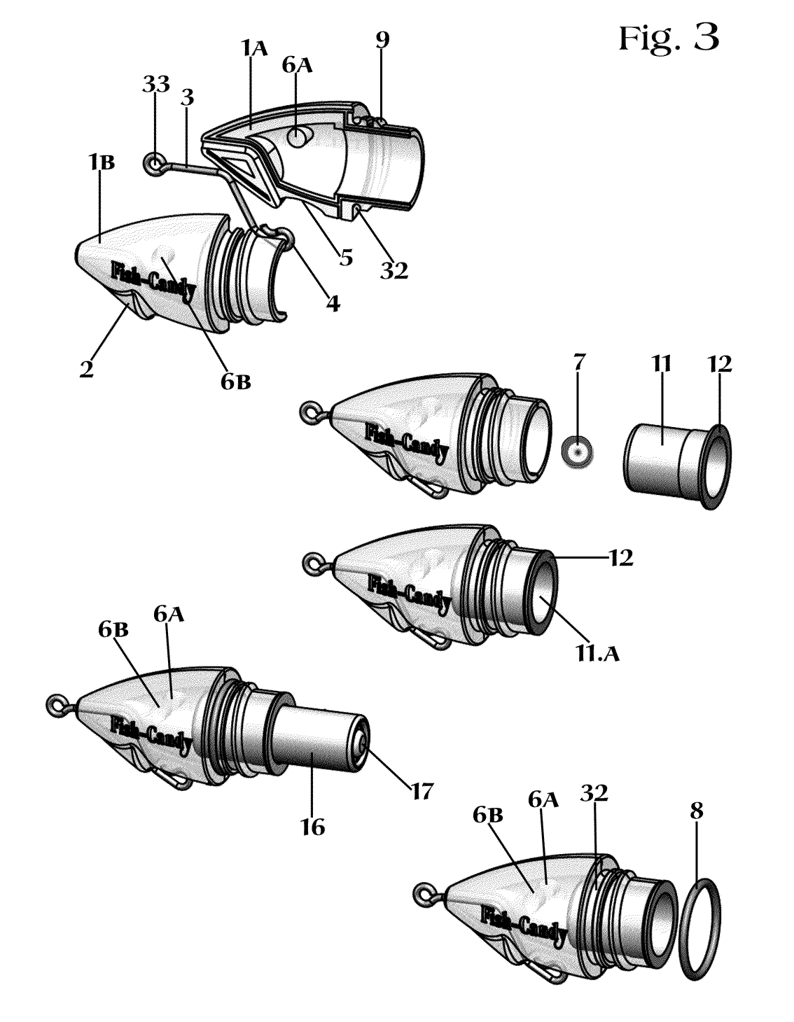

FIG. 4 illustrates the side, front and bottom profiles of the Head, illustrating the two halves of the Head placed together with views locating the Fluidic Wedge and the pan shaped depression of the Divot.

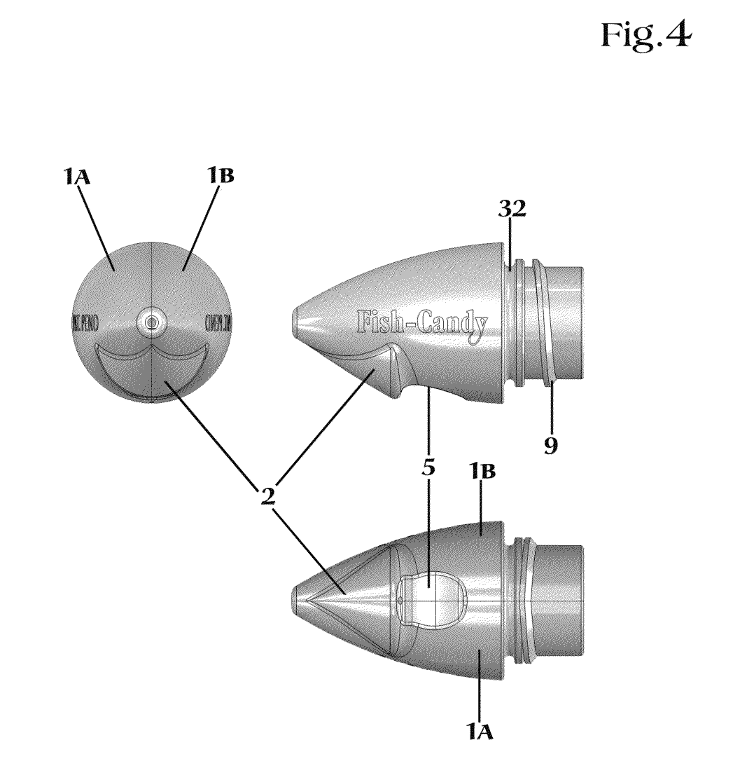

FIG. 5 shows the side profile of the lure assembly with features such as Battery Compartment, Battery, Forward Canister with Tab and Flange, Aft Canister with open aperture and Flange, and the Circuit Board.

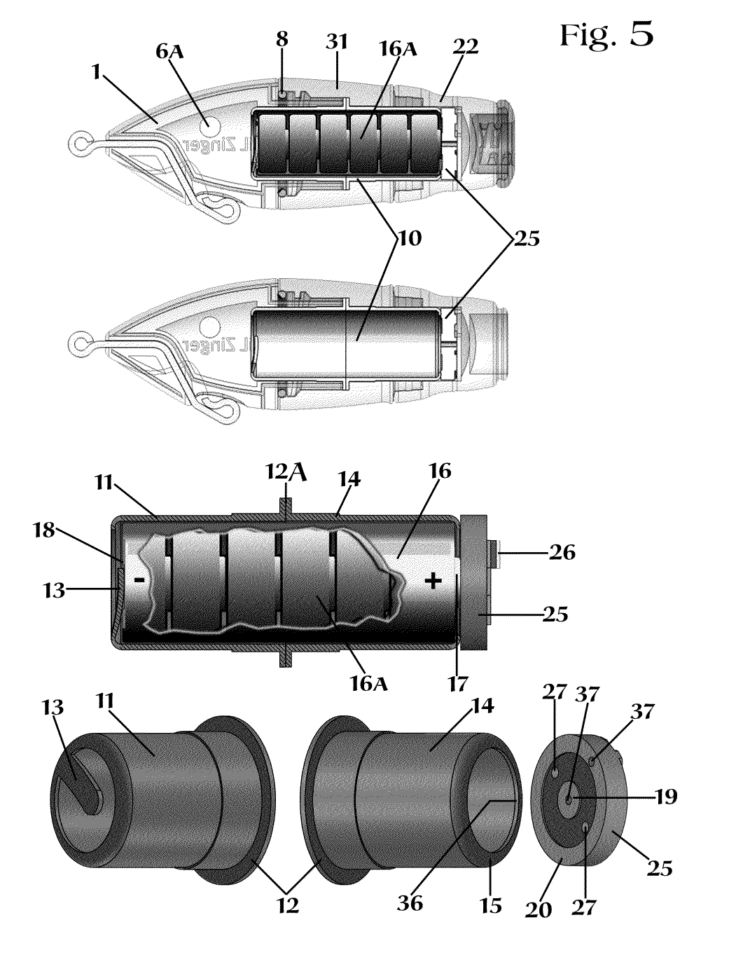

FIG. 6 illustrates the design and features of the Light-Cup, in two sizes.

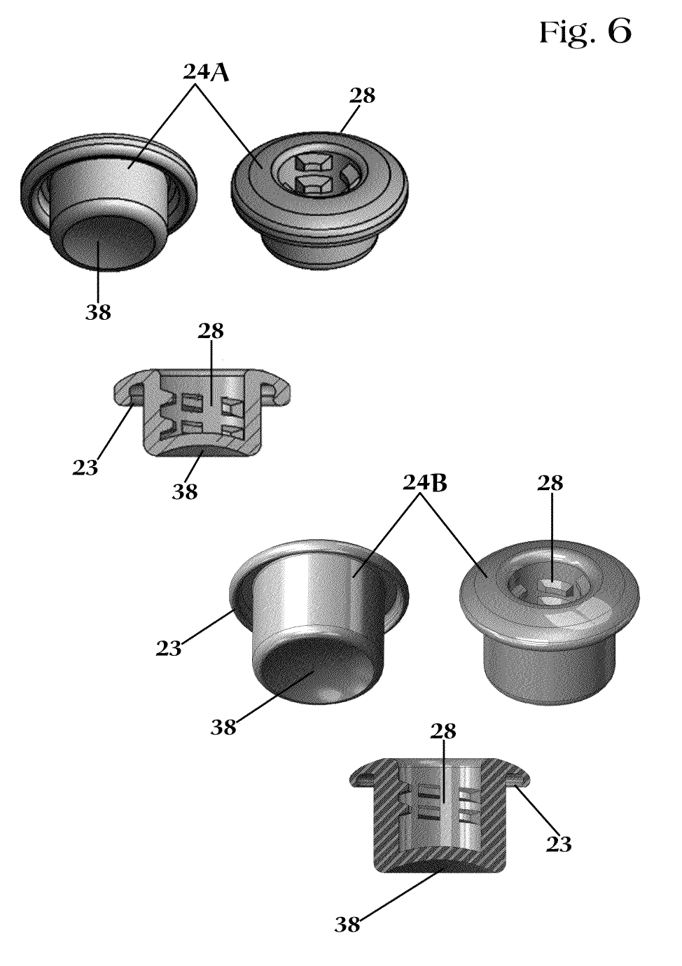

FIG. 7 illustrates the Mid-Section and Tail-Cap assemblies which, when joined, become the Body.

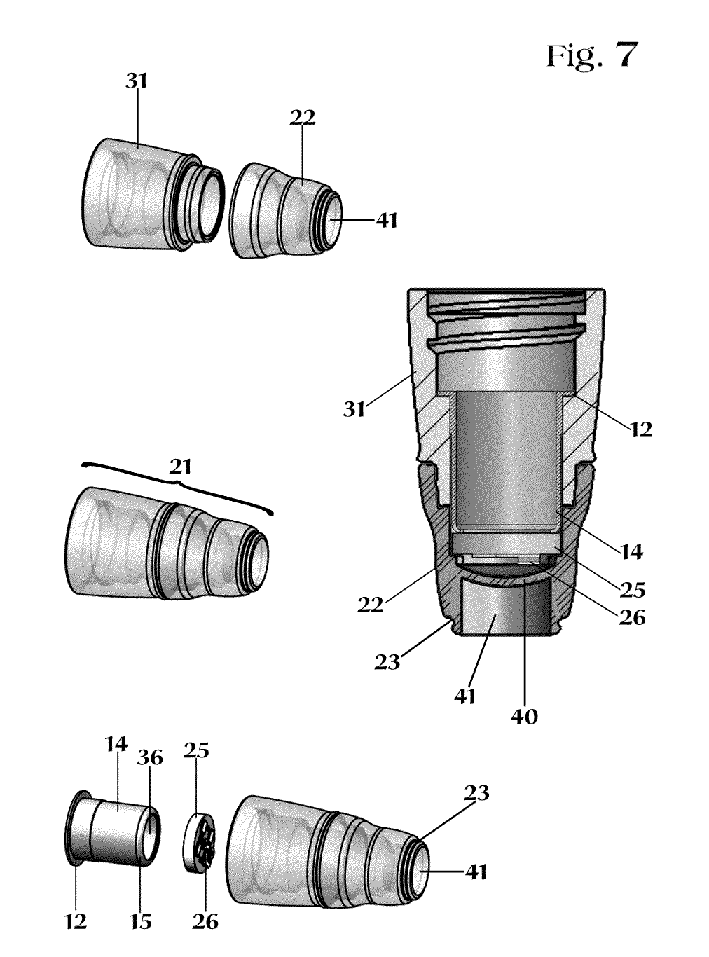

FIG. 8 illustrates the Body assembly with integral components in two sizes.

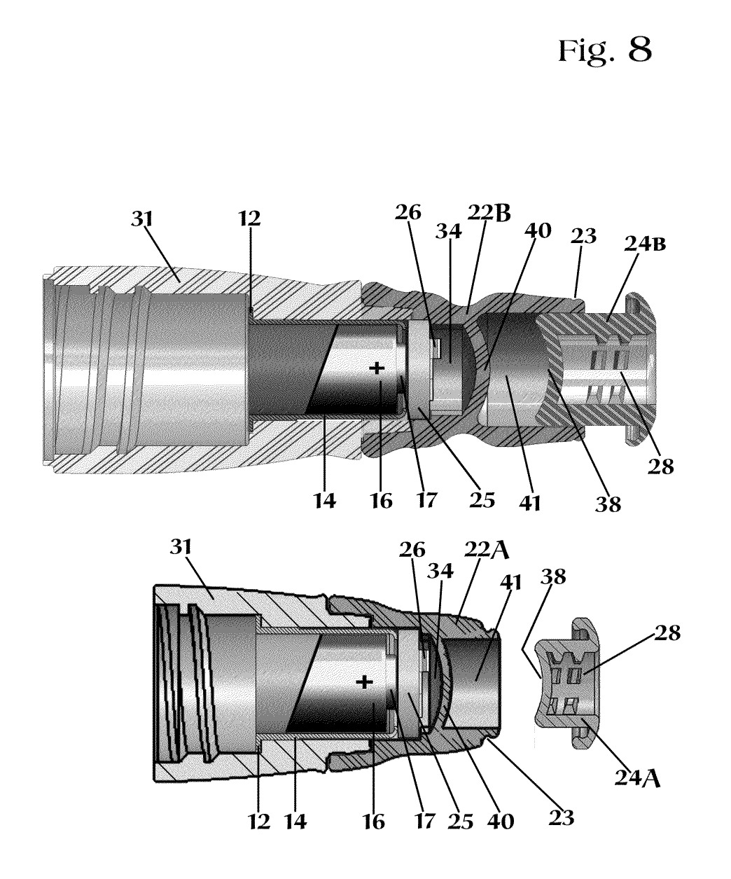

FIG. 9 illustrates the Hitch-Wire integrated into the Head further showing the normal and set diagrams of the Shepherd's Crook when pull force is exerted to the Hook.

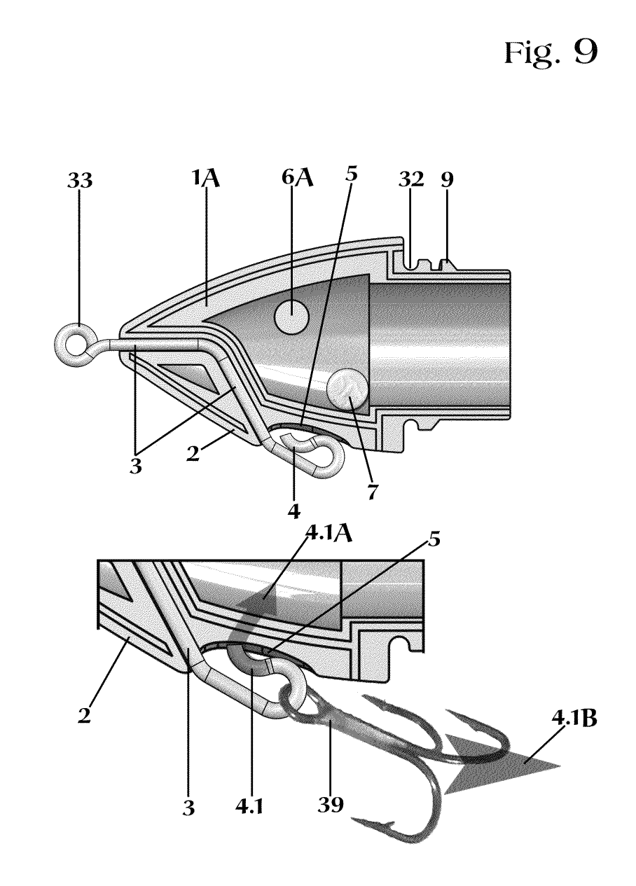

FIG. 10 shows the two sides of the Head with Eye Rod locations.

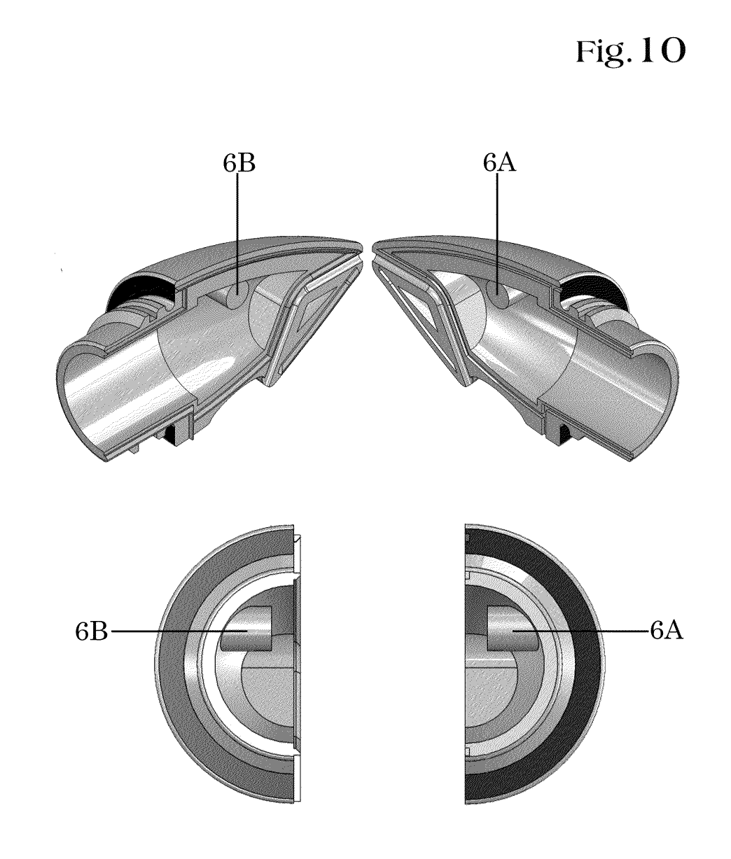

FIG. 11 illustrates the Field of Induction created around the lure when placed into the water.

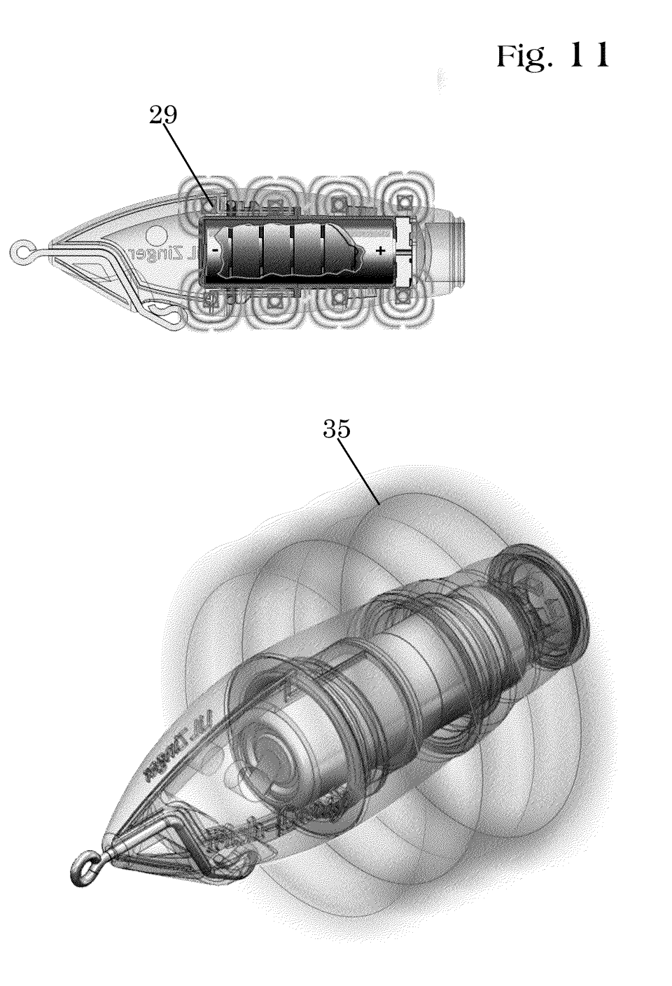

FIG. 12 illustrates the Circuit Board and its relevant components.

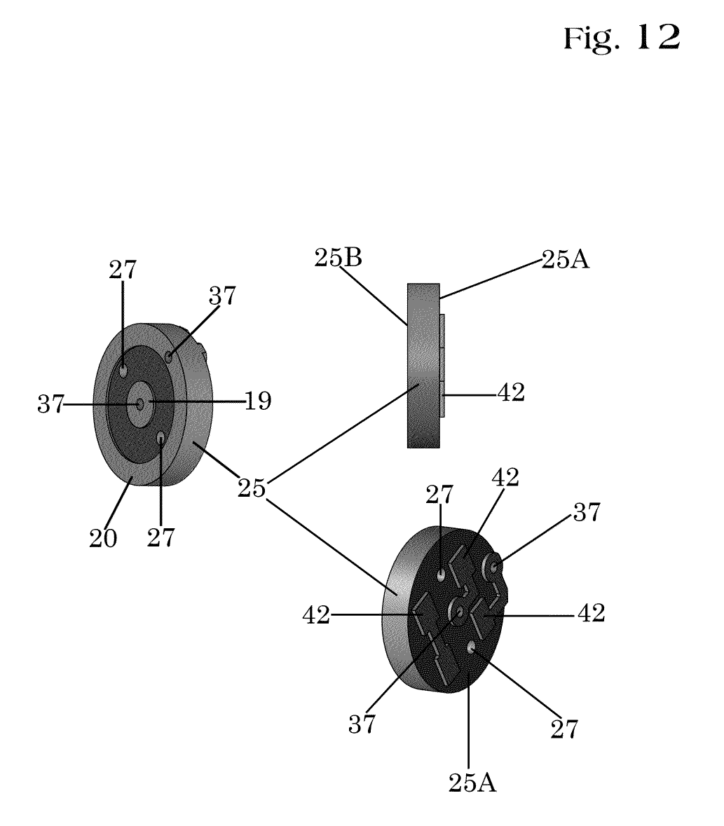

### DETAILED DESCRIPTION OF THE INVENTION

The lure HEAD (1) is an assembly made of two mirror-image halves (1A and 1B), advantageously sonically welded to form a permanent solid structure that possesses the following features and advantages. It is shaped like the head of a small fish, preferably manufactured from strong plastic material for strength and durability. As a module, the head can be removed from the MID-SECTION (21) when desired. With a hook (39) attached to the Head, it is very convenient for the angler to quickly change colored Body assemblies and return to fishing without affecting the attached hook, although the hook is very easy to change. The Head module is made from both solid and transparent colors, which serve to catch the eye of both fish and angler.

The FLUIDIC WEDGE (2) starts under and just behind the nose of the Head, protruding downwards and away from the bullet profile of the head, sweeping aft, ending abruptly and gently curving back into and blending with the form of the head (1). The Fluidic Wedge induces turbulence along the length of the lure assembly during lure retrieval, imparting a rhythmic motion to the entire lure assembly.

The Wedge adds weight to the Head which, in conjunction with the hydrodynamic effect of the Divot (5) as described below, causes the lure to naturally orient itself horizontally when being pulled, so that it is advantageously retrieved in a flat, straight line parallel with the surface of the water, creating a realistic motion, whereas traditional lures experience a non-parallel, upward motion upon retrieval, which makes their progression through the water less like that of prey fish. That weight addition is found to be particularly effective when the added mass of the Wedge is 1.5%-3.5% of the weight of the Head, and especially when the Wedge weighs approximately 2.5% as much as the Head.

The HITCH-WIRE (3) is made from strong stiff metallic wire commonly used in the art of fishing. It protrudes from the Head's bullet-shaped nose, having an eyelet (33) formed to securely tie or attach line, wire or devices commonly used in the art of fishing. From the eyelet (33), it enters into the Head (1), firmly and permanently encased within the Head embodiment. It exits from the underside centerline of the Head, behind the Fluidic Wedge (2), and terminates just below the Divot (5) depression. The aft end of the wire is formed into a fold, which turns back onto itself and creates an eyelet before turning upwards in a “shepherd's crook” (4) and terminating into the Divot (5). This single wire presents great advantages over having a threaded eyelet entering the nose, and/or a second threaded eyelet exiting the Lure body for attachment of a hook (39), as commonly found in current art. This design gains in advantage as the lure size increases, with the intent of attracting larger species. The added strength inherent in a single uncut connection between the fishing line and the hook becomes highly desirable.

The SHEPHERD'S CROOK (4) provides easy attachment and removal of hooks and other devices without the disadvantage of requiring a split ring, which limits flexibility when changing hooks and other devices. Furthermore, when a fish strikes the lure, the hook becomes imbedded in the jaw area of the fish. The fish's act of setting the hook (39) will cause tension (4.1B) to be exerted on the hook, which will tend to open (4.1) the Shepherd's Crook; however, the shape of the Divot (5) will block the movement (4.1A) of the terminal end of the Shepherd's Crook, which prevents the Shepherd's Crook from opening more than a tiny bit, thereby preventing the hook from detaching.

The DIVOT (5) is a shallow pan shaped depression, located bottom center of the Head, aft of the Fluidic Wedge (2). Hooks can be easily attached or detached from either side of the Head assembly using the Divot for side access to the Shepherd's Crook (4). The Divot minimizes the Shepherd's Crook profile against the form expressed in the shape of the Head, protecting the wire from snagging while not detracting overmuch from the fish-like appearance of the lure. The volume of the Head “lost” to the presence of this depression, as compared with a shape that follows the contour of the Head ahead of the Fluidic Wedge (2) and aft of the Divot, is particularly effective when in the range of 0.5% to 1.5% of the volume of the Head, especially when this “lost” volume is approximately 0.84%.

When the lure is retrieved, the pressure caused by the lure assembly moving forward increases as water passes below the Fluidic-Wedge, and then drops slightly but abruptly under the Divot. This change in pressure seeks to equalize under the Head-Body assembly and causes a pivot point to develop at the eyelet (33) on the lure nose, which imparts movement to the lighter aft section of the Body assembly (21), creating a level, rhythmic side to side oscillation.

The Head further benefits from the attractive properties of color by being made of solid colored or transparent tinted plastic. In a further variation when the Head is transparent—or even clear—the hitch wire can advantageously be anodized red, giving the appearance of gills and a mouth, visible from either side of the Head's profile.

Round EYE-RODS (6A and 6B) are formed on the interior cavity of the Head, one on each side. Each eye rod ends in a flat surface that can be painted to mimic a fish eye, with the effect of projecting the image of an eye feature to the Head's outer form, giving the Head a realistic presence.

RATTLE BEADS (7), made of a hard material such as plastic, can be inserted into the Head cavity to add a sound attraction to the lure during retrieval. This rattle sound is generated by the rhythmic motion of the lure as it moves through the water, which in turn affects the motion of beads contained in the Head cavity as they bounce from one interior surface to another.

The O-RING (8) provides a seal between the Head and Mid-Section assemblies when they are joined. It is replaceable and easily accessible, located in an annular channel (32) at the base of the Head's threaded stem. An optional enhancement would be to include more than one O-ring to further enhance water-tightness.

The TWIST-LOCK THREAD (9) enables an angler's hands, which may be slippery, cold or wet, to easily twist the Head away from the Body assembly (21) and separate the pieces. The thread begins at the aft end of the Head and terminates in a positive stop, located advantageously to provide optimal compression of the O-ring (8) by the Mid-Section (31) when tightened against the Head, and thereby provide optimal sealing, while at the same time preventing over-tightening. A second advantage is apparent when twisting the Head to the Mid-Section (31) in one turn, providing greater flexibility when exchanging a Mid-Section color for a different color choice.

The BATTERY COMPARTMENT (10), located where the Head meets the Mid-Section (31), is comprised of two metal canisters (11 and 14), which are tubes with mating flanges (12) which are permanently affixed into the Head (1) and the Mid-Section assemblies (21), respectively. The Forward Canister (11), enclosed in the Head (1), holds the negative terminal end (18) of the battery. It has a tab (13) formed at its base, a flat but flexible protrusion extending across its un-flanged end (15), which makes direct contact with the negative terminal of the battery (18). This provides an electrical pathway from the battery into the tab, through the Forward Canister and, by contact of the mating flanges (12A) of the two Canisters, into the Aft Canister (14), which is firmly affixed in the Mid-Section assembly. The Aft Canister has an aperture (36) located at its non-flanged end (15) to allow the positive battery terminal (17) to protrude and make contact with the positive contact (19) on the Circuit Board (25). The Aft Canister's base is held against the Circuit Board (25) contacting a negative annular trace (20) of the same diameter as the shoulder of the Canister. Battery Canisters are formed having a flat brim or flange (12) at their upper mating end which, when touching together (12A), form a contact surface to each other, ensuring current flow from the battery through the Canisters onto the circuit board (25). This provides an advantage to the overall strength of the design when the lure's Head (1) and Body assembly (21) are attached together, strengthening its tubular design. The battery (16), forming a tube, is quite strong and maintains its shape due to its internal stack of button-cells (16A), which are encased in a shroud supporting its overall tubular shape. The battery, having a tubular form and inserted into the lure's also-tubular Canisters, provides both a source for conduction and, to even greater advantage, provides “induction of energy” (29) into the surrounding water, while adding overall strength to the design. Therefore, this lure gains in overall structural strength and rigidity by enclosing tubes within other tubes. The advantage is that the design of the lure can be made as small as the smallest tube allows.

The lure BODY is formed when the Tail-Cap (22) is joined, preferably by sonic welding, to the Mid-Section (31), making a complete Body assembly (21). The Tail-Cap (22) becomes permanently attached to the Mid-Section (31), becoming a unified Body assembly. The overall shape of the Body assembly is hydro-dynamically beneficial to the lure's performance. The Mid-Section (31) is made of similar solid, translucent and transparent colors and materials used in making the Head. The Tail-Cap (22), which is made of water-clear material, is permanently attached to the Mid-Section and provides the lure with a profile which, when screwed to the Head, creates the advantageous appearance of a small prey fish.

The TAIL-CAP (22), a fully transparent, preferably permanent sonically welded appendage attached to the Mid-Section (31). It possesses two cavities separated by a wall shaped like a lens (40). The forward cavity (34) retains watertight integrity as an appendage to the Mid-Section (31), and contains the Circuit Board (25). The second chamber aft of the curved lens divider (40) is open and provides a light path to attachments inserted into this aft chamber (41). The outer trailing end of this open chamber contains an annular channel (23), which provides a Stretch-On capture feature to attach and retain the Light-Cup (24) onto the Tail-Cap, making it easy to remove and attach. The Tail-Cap functions to allow internal light to become useful as both direct and indirect light benefiting the novel design of the lure in several ways. The internal lens (40) surface directs the light from the LED (26), mounted on the Circuit Board (25) within the forward cavity (34), to penetrate the internal lens feature and illuminate the Tail-Cap material itself, as well as through the lens (40) and onto attachments placed in the external cavity just aft of the lens. As a focused point of light, adding illumination to attachments when placed into the aft cavity promotes a greater opportunity for attracting fish. The profile of the Tail-Cap, taking various shapes between lure sizes (22A and 22B), has a contoured bulb shape which provides a means to hold material commonly used in the manufacturing of skirts and tubes. When tubes and skirts are stretched over the Tail-Cap, thereby securing and attaching them to the Tail-Cap surface, the indirect light provides illumination to the attachments' form, which makes them significantly more attractive and effective than in any prior art application.

The CIRCUIT BOARD (25) is a small, preferably circular two-sided board with electrical pads on the front of the board (25B) and components mounted onto the backside (25A) of the board. The Circuit Board has several conductively-plated tubes—vias (37)—connecting the front of the board to the back of the board, providing electrical pathways from one side of the board to the other, which allow conduction between the battery and the components affixed on the back side of the Circuit Board. There are two Vent Holes (27) that pass through the Circuit Board providing a means to equalize the temperatures of the Mid-Section (31) and the Tail-Cap (22). The Circuit Board is held in place by the bottom end of the aft Canister (14) which is fully inserted and fixed inside the Mid-Section assembly, having its shoulder pressed against the front surface of the Circuit Board making contact with a mating metallic annular negative circuit (20) that is fixed into the substrate of the board's surface. This sandwiches the Circuit Board against a shelf within the Tail-Cap (22) cavity (41), providing a permanent seat for the Circuit board, holding it in place without the use of screws or other fasteners. It has been found that different fish respond to different light wavelengths and tones found throughout the color and temperature spectrum, therefore this lure will capitalize on the use of these tone variations, utilizing a variety of LED (26) choices affixed to the Circuit Board, which emit light in the color spectrum from warm to cool. The location for emitting both direct and indirect light is optimized for illuminating attachments and providing illumination to the lure itself. The surface of the Circuit Board is coated with a colored mask, which will also be an advantage when seen through the transparent Tail-Cap (22), taking on the appearance of internal organs of a small prey fish, thereby giving the advantage of adding realism to the overall modular design.

The LIGHT-CUP (24) has a mushroom shape with a threaded internal cavity (28) at its aft, external end and a smooth concave surface (38) at its forward, inserted end, advantageously made with material that is soft yet pliable while retaining color transparency. This provides a means to affix the Light-Cup into the aft Tail-Cap chamber (41) snugly while stretching over and onto the outer lip being affixed to the aft end of the Tail-Cap. The LIGHT-CUP (24) is provided in a variety of colors. The Light-Cup is attached onto the aft end of the Tail-Cap (22), and functions as a modular filter of varying color translucency and/or is fully transparent; having a variety of transparent color choices of various wavelengths and temperatures provides a means of illumination and therefore becomes an agent in the attraction of fish to this lure, taking advantage of the fact that fish can see and are visually attracted to motion and light. Also, the threaded aft cavity (28) provides further advantages for affixing appendages that are held in place when inserted into this threaded chamber, adding to the modularity and attraction capabilities of this Lure. A further benefit is bait manufactured to provoke attraction by smell, which can be stuffed within the aft cavity of the Light-Cup and held in place by the threaded protrusions within.

The light emitted by the LED (26) is focused onto a concave surface (38) within the Tail Cap structure itself. This provides direct light illumination for attachments and accessories, which can be pressed onto the exterior of the Tail Cap (22) or into the attached Light-Cup's aft cavity (28). Furthermore, indirect lighting is created from the same source but becomes transmitted through the Tail Cap material and into the transparent areas of the Mid-Section and attached Head, giving an overall illuminating effect to the lure's form. Indirect light is beneficial in allowing a prey fish to see the lure in the water from almost any direction. When fishing the lure at depths where certain light spectrums are not visible, the indirect light is highly visible and gives the appearance similar to that of a visible spot of light seemingly floating within the water medium. Commonly known for stimulating house pets, this spot of light is highly effective in attracting aquatic species as well. In the application of this art, the indirect light provides the source for stimulating fish when attaching a skirt or tube to the lure. Skirts and Tubes are tubular in shape, being attachable devices common in the art of fishing which are fabricated from soft vinyl or silicone and may be transparent when attached, promoting an advantage when illuminating the attachment, giving the lure an overall life-like presence in darker or deeper water.

INDUCTION (29) is created as a direct result of the internal Battery Compartment (10) design. The nature of induction is the transference of energy from one medium to another. The battery is enclosed in its Battery Canisters (11 and 14), which form a tubular shell around the battery (10), all of which is then encased in a watertight embodiment such as this lure and placed in water. This creates induction (29), creating a field of energy (35) around the perimeter of the lure, detectable by predator fish. As applied herein, the induction of an energy field (35) creates an attractant to the greater advantage of this Lure. Many fish are known to have the ability to sense motion, including their own, due to their lateral line system. Fish have the ability to sense motion, and the small electrical fields emitted from an injured fish, by means of their lateral lines located on surface areas across their sides and, in some cases, in the general area of their heads. This induced electrical field (35) mimics that of an actual fish, stimulating predator fish to approach and strike.

The BATTERY (16) is easily replaced in the field, and is advantageously rechargeable.

As a further aid to clarity and comprehension, a numerical list of the various features of this invention appears below.

### MODULAR LURE

1. HEAD
a. 1A Right side
b. 1A-1 Close-up
c. 1B Left side

2. FLUIDIC WEDGE

3. HITCH-WIRE

4. SHEPHERDS CROOK
a. 4.1 Set position
b. 4.1A Direction of set position
c. 4.1B Direction of pull to set

5. DIVOT

6. ROUND EYE-RODS
a. 6A Right side
b. 6B Left side

7. RATTLE BEAD

8. O-RING

9. TWIST-LOCK THREAD

10. BATTERY COMPARTMENT

11. FORWARD CANISTER
a. 11A Forward Canister Inserted

12. CANISTER FLANGE
a. 12A Flange to Flange contact

13. FORWARD CANISTER TAB

14. AFT CANISTER

15. Un-FLANGED END OF CANISTER

16. BATTERY
a. 16A Battery cells

17. POSITIVE BATTERY TERMINAL

18. NEGATIVE BATTERY TERMINAL

19. POSITIVE CONTACT on circuit board

20. NEGATIVE ANNULAR TRACE on circuit board

21. BODY ASSEMBLY

22. TAIL-CAP
a. 22A Small lure
b. 22B Medium lure

23. STRETCH-ON capture feature

24. LIGHT-CUP
a. 24A Small lure
b. 24B Medium lure

25. CIRCUIT BOARD
a. 25A Back side
b. 25B Contact front side

26. LED

27. VENT HOLES

28. THREADED AFT CAVITY, Light-Cup

29. INDUCTION of energy

30. LURE ASSEMBLY
a. 30A Small lure assembly
b. 30B Medium lure assembly

31. MID-SECTION
a. 31A Small lure
b. 31B Medium lure
32. O-RING CHANNEL

33. EYELET

34. Forward Cavity, Tail-Cap

35. Electrical field of energy

36. Aft Canister Aperture

37. VIA, plated through-hole, circuit board

38. CONCAVE FOCAL SURFACE

39. HOOK, attached

40. Lens, Tail-Cap

41. Aft Chamber, Tail-Cap

42. COMPONENT PADS

I claim:

1. A modular fishing lure, comprising a head, a middle and a tail section which, when the sections are assembled to each other, describes the rough outline of a fish;
said sections being designed to be capable of being freely disassembled from each other and replaced with other sections of differing appearance, such differences including opacity, translucence, transparency, color, decoration and shape;
with sections with specific characteristics selected to appeal to specific fish.

2. The lure of claim 1, wherein said lure contains a power source comprising one or more batteries surrounded by one or more tubular conductive structures which, when energized, inductively creates an energy field around the lure, which energy field resembles and mimics the energy fields emitted by fish.

3. The lure of claim 2, in which one or more of the three sections is translucent or transparent, the lure further containing a light source energized by the power source, which light source causes the one or more sections to shine or glow.

4. The lure of claim 1, wherein the head section tapers toward its front, which is opposite where it assembles to the middle section, and wherein, extending aft from the front of the head section, there is on one side a rounded, wedge-like protrusion which flares away from the contour of the head and which is weighted so as to cause this one side to orient itself away from the surface when the lure is submerged in water, causing the side with the protrusion to be the bottom of the head section and thus of the lure;
and wherein the protrusion is shaped so as cause turbulence when the lure is retrieved, imparting a motion to the lure at variance with the direction in which it is being retrieved.

5. The lure of claim 4, in which the protrusion adds mass to the head section in the range of 1.5 to 3.5% of the mass of the head section.

6. The lure of claim 4, in which the protrusion flares away from the contour of the head section for approximately half the length of the head section, and wherein the head section is further equipped with a shallow concave area on its bottom just aft of the aft end of the protrusion, and which concave area is shaped so as to impart further motion to the lure at variance with the direction in which it is being retrieved.

7. The lure of claim 6, in which the volume lost to the concave area, as compared with a head section having a contour in that area similar to adjoining areas of the head section, is in the range of 0.5 to 1.5% of the volume of the head section.

8. The lure of claim 6, in which the head section is equipped with a hitch wire composed of a piece of solid wire or similar strong, stiff material;
the hitch wire being shaped into an eyelet or other shape for attaching fishing line at its front end, which protrudes from the front of the head section;
the hitch wire then passing through the head section and being secured within the head section;
the hitch wire exiting the head section at the bottom of the head section in the transition area between the protrusion and the concave area;
the hitch wire continuing aftward roughly parallel to the general contour of the head section until it is approximately opposite the aft end of the concave area;
the hitch wire then curling up toward the concave area touching or nearly touching the concave area and curving back on itself more than 180 degrees describing a partial eyelet and then curling away from itself and forward and toward the concave area and terminating near the concave area with the back portion of the hitch wire resembling the shape of a shepherd's crook;
so that when a fish hook is secured in the crook area of the hitch wire and force is exerted on the hook rearward or downward in relation to the lure, any tendency of the crook to open to any significant degree is stopped by the posterior tip of the hitch wire rotating into the surface of the concave area and having its further rotation arrested thereby.

9. The lure of claim 1, in which the head section contains a hollow area, which hollow area is supplied with beads or other small, hard articles which will move within the hollow area in response to movement of the lure, and which will rattle and cause noise which will attract fish.

10. The lure of claim 1, wherein the head section is equipped with rods which terminate at the left and right sides of the head section, respectively, shaped and colored to give the impression of fish eyes.

11. The lure of claim 3, wherein the tail section is provided with a cavity at its aft end, which cavity is provided with screw threads, contouring, faceting or other means for receiving and holding skirts and tubes and other appendages used for attracting fish, and/or bait.

12. The lure of claim 11, wherein the tail section is translucent or transparent and its cavity at its aft end receives an exchangeable light-diffusing tail piece, the color and light-diffusing characteristics of the tail piece utilized being matched to the proclivities of the fish being targeted by the lure.

13. The lure of claim 12, wherein the tail piece is also provided with a cavity at its aft end, which cavity is provided with screw threads, contouring, faceting or other means for receiving and holding skirts and tubes and other appendages used for attracting fish, and/or bait.
